(19) United States
(12) Patent Application Publication
(10) Pub. No.: US 2010/0268935 A1
(43) Pub. Date: Oct. 21, 2010

(54) METHODS, SYSTEMS, AND COMPUTER READABLE MEDIA FOR MAINTAINING FLOW AFFINITY TO INTERNET PROTOCOL SECURITY (IPSEC) SESSIONS IN A LOAD-SHARING SECURITY GATEWAY

(76) Inventors: Richard Rodgers, Charlestown, MA (US); James Cervantes, Lexington, MA (US)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/467,242

(22) Filed: May 15, 2009

Related U.S. Application Data
(60) Provisional application No. 61/171,306, filed on Apr. 21, 2009.

(51) Int. Cl. H04L 29/06

(52) U.S. Cl. 713/153

(57) ABSTRACT

Methods, systems, and computer readable media for maintaining flow affinity to IPSec sessions in a load-sharing security gateway are disclosed. According to one embodiment, the method includes receiving packets at a security gateway that provides communications of packet flows between source and destination entities using IPSec sessions. For each packet, it is determined whether the packet is assigned to an existing packet flow between a source and a destination entity that is being processed by the SG. In response to determining that the packet belongs to an existing flow, the packet is forwarded to a processing element associated with that flow and IPSec processing is performed at the processing element. In response to determining that the packet does not belong to an existing flow, a new flow is defined and assigned to a next available processing element. IPSec processing is performed for the flow at the next available processing element.

### PRIORITY CLAIM

This application claims the benefit of U.S. Provisional Patent Application No. 61/171,306, filed on Apr. 21, 2009, the disclosure of which is incorporated herein by reference in its entirety.

### TECHNICAL FIELD

The subject matter described herein relates to processing packet flows at a security gateway. More specifically, the subject matter relates to methods, systems, and computer readable media for maintaining flow affinity to IPSec sessions for packets processed by a load-sharing security gateway.

### BACKGROUND

A security gateway (SG) is a networking device that uses Internet Protocol Security (IPSec) to provide secure communications for packet flows it handles. IPSec is a framework of open standards for protecting communications between network devices over Internet Protocol (IP) networks through the use of cryptographic security services. Two important components of IPSec—“Security architecture for IP” and “ESP protocol”—are defined in Internet Engineering Task Force (IETF) request for comments (RFCs) 4301 and 4303, respectively, and are incorporated by reference herein in their entireties. For example, SGs may include session border controllers or firewalls that lie between “untrusted” access networks, such as the Internet, and “trusted” networks, such as core networks and/or the public switched telephone network (PSTN).

Conventional SGs typically include a single, shared set of processing resources (e.g., processor(s) and memory) configured, for example, as a single processing element or blade within a chassis. However, because the processing demands associated with processing IPSec sessions can often be greater than the capability of a single processing element, SGs may be implemented as a cluster of multiple, identical processing elements (aka, “security processors”) that share the processing load for packets processed by the load-sharing SG.

As used herein, an “IPSec session” or “session” refers to all packets and packet flows between a source and a destination network entity that requires IPSec processing. IPSec processing may include any type of packet processing that utilizes IPSec standards framework, as defined above, for providing secure communications between two entities. Exemplary IPSec processing functions may include, but are not limited to, packet encryption/decryption, encapsulation, protocol and key negotiation, and authentication.

As used herein, a “packet flow” or “flow” refers to a sequence of one or more packets transmitted between a source and a destination network entity that share a common characteristic for indicating to intermediate network devices (e.g., routers, switches, gateways) that packets in the flow should be processed similarly/share a common purpose (e.g., port 80 indicates an HTTP flow). There may be multiple active flows between a source and a destination as well as packets not associated with any flow. More specifically, as used herein, a flow may be defined as all packets having a common N-tuple in their respective packet headers. An N-tuple refers to a list (i.e., an ordered set of values or elements) of packet header data elements, where N is a user-defined value indicating the number of data elements in the packet header to be included in the list. For example, an unencrypted TCP/IP packet may include the 5-tuple <source IP address, source port number, destination IP address, destination port number, protocol>. Therefore, all packets sharing the same 5-tuple may belong to the same unencrypted packet flow. Similarly, an encrypted packet flow may be defined by the 4-tuple <source IP address, destination IP address, protocol, SPI>.

In a conventional load-sharing SG, each processing element is responsible for creating IPSec sessions and performing IPSec processing for at least a subset of the packet flows received by the SG. Thus, each processing element separately maintains IPSec information for each of the flows it processes. Exemplary types of IPSec information may include information such as security protocols, encryption/decryption keys, and initialization vectors.

Conventional load-sharing SGs also load share packet flows between multiple processing elements using conventional packet inspection. Conventional packet inspection includes examining predetermined N-tuple packet header data in order to determine the flow to which the packet belongs. Once a flow is determined, the flow is load-shared among the processing elements.

One problem associated with conventional load-sharing SGs is that the load sharing component does not know to which IPSec session a given flow belongs using conventional packet inspection. In other words, conventional load-sharing assigns packet flows to processing elements without regard for the IPSec session to which the flow belongs. As a result, conventionally-load-shared packets belonging to an IPSec session may be improperly processed, dropped, or corrupted because each processing element may have an incomplete and/or inaccurate picture of the correct state of the IPSec session. Therefore, it is desirable for the same processing element be responsible for processing all flows for a given IPSec session in order to avoid cumbersome synchronization between multiple processing elements and/or storage and maintenance of redundant state information.

Accordingly, in light of these difficulties, a need exists for improved methods, systems, and computer readable media for maintaining flow affinity to sessions in a load-sharing security gateway.

### SUMMARY

Methods, systems, and computer readable media for maintaining flow affinity to IPSec sessions in a load-sharing security gateway are disclosed. According to one embodiment, the method includes receiving packets at a security gateway that provides communications of packet flows between source and destination entities using IPSec sessions. For each packet, it is determined whether the packet is assigned to an existing packet flow between a source and a destination entity that is being processed by the SG. In response to determining that the packet belongs to an existing flow, the packet is forwarded to a processing element associated with that flow and IPSec processing is performed at the processing element. In response to determining that the packet does not belong to an existing flow, a new flow is defined and assigned to a next available processing element. IPSec processing is performed for the flow at the next available processing element.

A system for maintaining flow affinity to IPSec sessions is also disclosed. The system includes a load-sharing security gateway that provides communications of packet flows between source and destination entities using IPSec sessions. The security gateway includes a plurality of processing elements for performing processing for packets and packet flows. A load-sharing module is communicatively coupled to each of the plurality of processing elements and configured to load share packet flows among the processing elements. The load-sharing module receives packets and, for each packet, determines whether the packet is assigned to an existing packet flow between a source and a destination entity that is being processed by the SG. In response to determining that the packet belongs to an existing flow, the packet is forwarded to a processing element associated with that flow and IPSec processing is performed at the processing element. In response to determining that the packet does not belong to an existing flow, a new flow is defined, the flow is assigned to a next available processing element, and IPSec processing is performed for the flow at the next available processing element.

The subject matter described herein for maintaining flow affinity to IPSec sessions in a load-sharing security gateway may be implemented using a computer readable medium to having stored thereon executable instructions that when executed by the processor of a computer control the processor to perform steps. Exemplary computer readable media suitable for implementing the subject matter described herein includes disk memory devices, programmable logic devices, and application specific integrated circuits. In one implementation, the computer readable medium may include a memory accessible by a processor. The memory may include instructions executable by the processor for implementing any of the methods for maintaining flow affinity to IPSec sessions in a load-sharing security gateway described herein. In addition, a computer readable medium that implements the subject matter described herein may be distributed across multiple physical devices and/or computing platforms.

### Terminology

An ingress packet is a packet received from an external source.

An egress packet is a packet that originates from a processing element.

A client IP address refers to one of a pool of IP addresses specific to a SG that are assigned by the SG to every subscriber who makes a connection through the SG. Client IP addresses are assigned by a processing element during IPSec session creation. A client IP address database includes entries associating each known client IP address with the processing element responsible for establishing the IPSec session. As a result, an IPSec session may be identified by its client IP address.

Security parameters index (SPI) identifies the security parameters in combination with IP address. The SPI is an identification tag added to the header while using IPSec for tunneling the IP traffic. This tag helps discern between two traffic streams where different encryption rules and algorithms may be in use. SPI: the 32-bit value used to distinguish among different SAs terminating at the same destination and using the same IPSec protocol. The SPI enables the receiving system to select the SA under which a received packet will be processed. An SPI has only local significance, since is defined by the creator of the SA. Sequence number includes a monotonically increasing number, used to prevent replay attacks.

Encapsulating Security Payload (ESP) is a member of the IPSec protocol suite. It is the portion of IPSec that provides origin authenticity, integrity, and confidentiality protection of packets. ESP also supports encryption-only and authentication-only configurations, but using encryption without authentication is strongly discouraged because it is insecure. Unlike Authentication Header (AH), ESP does not protect the IP packet header. However, in Tunnel Mode, where the entire original IP packet is encapsulated with a new packet header added, ESP protection is afforded to the whole inner IP packet (including the inner header) while the outer header remains unprotected. ESP operates directly on top of IP, using IP protocol number 50. ESP is further defined in RFC 4303 which is incorporated by reference herein in its entirety.

### BRIEF DESCRIPTION OF THE DRAWINGS

The subject matter described herein will now be explained with reference to the accompanying drawings of which:

FIG. 1 is a block diagram of an exemplary load-balancing security gateway suitable for maintaining flow affinity to sessions according to an embodiment of the subject matter described herein;

FIG. 2 is a network diagram of an exemplary network configuration including a load sharing security gateway that maintains flow affinity to sessions according to an embodiment of the subject matter described herein;

FIGS. 3A and 3B are a flow chart showing exemplary steps performed by a load-balancing security gateway for maintaining flow affinity to IPSec sessions in according to an embodiment of the subject matter described herein;

FIG. 4 is a flow chart showing exemplary steps performed when an IPSec session is created according to an embodiment of the subject matter described herein;

FIG. 5 illustrates a scenario in which a received packet is not associated with any known flow or session and, therefore, is routed to the next available processing element according to an embodiment of the subject matter described herein;

FIG. 6 illustrates a scenario in which a received packet is associated with a previous flow and IPSec session and, therefore, is routed to the same processing element associated with the flow/session according to an embodiment of the subject matter described herein; and

FIG. 7 illustrates an alternative scenario in which a received packet belongs to a new packet flow but a known IPSec session and, therefore, is routed to the same processing element associated with the session according to an embodiment of the subject matter described herein.

### DETAILED DESCRIPTION

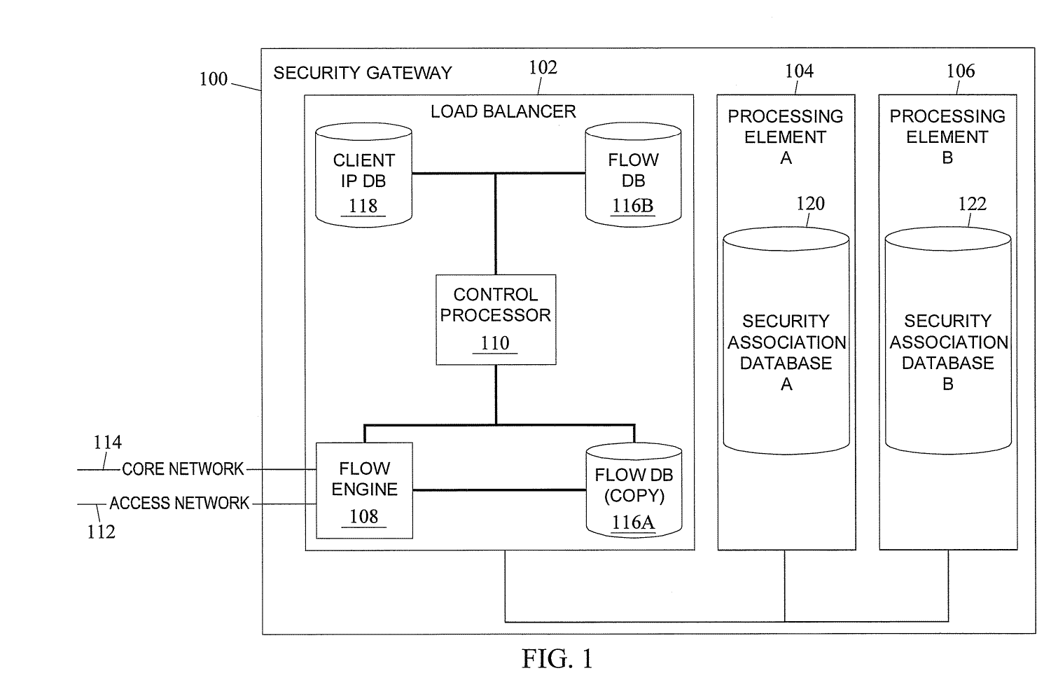

FIG. 1 is a block diagram of an exemplary load-balancing security gateway suitable for maintaining flow affinity to sessions according to an embodiment of the subject matter described herein. Referring to FIG. 1, security gateway 100 may include a load sharing module and two or more processing elements (also referred to as “security processors”) for distributing packets to the processing elements and processing the packets, respectively. For example, SG 100 may include load sharing module 102 for distributing packets among processing elements 104 and 106. While only two processing elements are shown in FIG. 1, additional processing elements may be included in SG 100 without departing from the scope of the subject matter described herein. SG 100 may include a chassis having one or more cards or blades being connected together via a backplane. As such, functional elements of load sharing module 102 and/or processing elements 104 and 106 may be implemented on different blades or may be combined and implemented on a single blade. SG 100 may include any networking device capable of performing IPsec processing for packets, including IPSec session establishment, IPSec key exchange (IKE) negotiation, and packet encryption/decryption. Exemplary types of security gateways suitable for implementing the subject matter described herein include a session border controller (SBC) and a firewall.

Load balancer 102 may be configured to send and receive packets from connected network devices as well as to distribute packets among processing elements 104 and 106 for processing. For example, when a packet is received at an ingress port of SG 100, the packet may initially be routed to load balancer 102 for a determination as to where the packet is to be sent. For example, packets that do not require any IPSec processing may be sent to an appropriate exit interface associated with the packet's destination or, alternately, packets that must be IPSec processed may be sent to an appropriate processing element. In order to make this determination, load balancer 102 may be divided into multiple functional elements that are associated with various databases which will now be described in greater detail below.

Load balancer 212 may include a flow engine 108 for sending/receiving packets to/from each of access network 112 and core network 114. Access network 112 may include an untrusted communications network, such as the Internet, in which IPSec secured communications are desired. For example, communication sessions transmitted via untrusted access network 112 may require IPSec encryption in order to prevent unwanted eavesdropping of the communication session. Core network 114, on the other hand, may include a trusted communications network in which IPSec-secured communications are not necessary. For example, encrypting packets that traverse a backbone communications network managed by large network providers or the PSTN is not necessary because untrusted devices are not directly connected to any core network communications nodes or links.

Flow engine 108 may also be associated with a flow database 116A in order to locate matching entries for determining whether a received packet matches an existing flow. If the received packet matches an existing flow, flow engine 108 may forward the packet to one of processing elements 104 or 106 (for IPSec packets) or to an exit interface (for non-IPSec packets) for delivery to a destination or next hop address. Because most packets received by flow engine 108 will match an existing flow, it is appreciated that forwarding decisions are made solely using flow engine 108 for the majority of packets, without resorting to slower, exception-based processing performed by control processor 110.

Control processor 110 may receive information associated with packet flows from flow engine 108 when the packet does not match an existing flow. Based on this information, control processor 110 may determine which processing element 104 or 106 a given packet should be sent to, and instruct flow engine 108 to forward the packet to the determined processing element 104 or 106. In order to make its determinations, control processor 110 may be associated with flow database 116B and client IP address database 118.

Flow database 116B may include flow entries containing information identifying each flow (e.g., N-tuple) being associated with a processing element identifier to which the flow is assigned. Flow database 116B may include separate flow entries for ingress flows and egress flows, as well as for IPSec flows (e.g., ESP flows) and non-IPSec flows (e.g., cleartext packet flows). For example, an IPSec flow may be identified by the 4-tuple <source IP address, destination IP address, protocol, SPI>, while a non-IPSec flow may be identified by the 5-tuple <source IP address, destination IP address, source port number, destination port number, protocol>. The processing element identifier may be any suitable value that uniquely identifies a processing element within security gateway 100. For sake of simplicity, processing element 104 shown in FIG. 1 is assigned processing element identifier A and processing element 106 is assigned processing element identifier B.

Flow databases 116A and 116B may be identical copies of each other and may be synchronized by control processor 110. It is appreciated that when a new entry is made to flow databases 116A or 116B, it is made by control processor 110. Therefore, control processor 110 may be responsible for writing to both of flow databases 116A and 116B. Flow database 116A may be implemented in hardware for faster access such that flow engine 108 may search flow database 116A for determining whether a received packet matches an existing flow. Because flow database 116B is not used for such fast searches, it may be implemented in software. Thus, while control processor 110 may read and/or write to both flow databases 116A and 116B, flow engine 108 may only read from flow database 116A in the exemplary embodiment shown in FIG. 1.

Client IP address database 118 may include client IP addresses that are associated with processing element identifiers. As used herein, a client IP address refers to one of a pool of IP addresses specific to a SG that are assigned by the SG to every subscriber who makes a connection through the SG. For example, when an external network device initially connects to SG 100 and establishes an IPSec session, the IP address of the device may be determined and becomes a client IP address associated with SG 100. Likewise, each of processing elements 104 and 106 may be associated with IP addresses and, therefore, upon establishing an IPSec session, may also become a client IP address associated with SG 100. Because client IP addresses are assigned by one of processing elements 104 or 106 during IPSec session creation, client IP address database includes entries that associates each known client IP address with the processing element responsible for establishing the IPSec session. As a result, an IPSec session may be identified by a client IP address. Put another way, an IPSec session includes all packet flows associated with a given client connection and, therefore, an IPSec session may include all flows associated with a given client IP address in client IP address database 118.

Each of processing elements 104 and 106 may include a security association database (SAD) 120 and 122, respectively, for maintaining IPSec SA information necessary for processing IPSec packets (e.g., encryption/decryption). For example, SADs 120 and 122 may include ESP encryption algorithm information (e.g., DES, MD5, etc.), encryption keys, an initialization vector (IV), an IV mode, and similar information. Thus, when a packet is received by processing elements 104 that requires IPSec processing, SAD 120 may be consulted in order to properly process the packet based on previously negotiated standards, protocols, etc. during establishment of the IPSec session. Once a packet has been processed by one of processing elements 104 or 106, the packet may be returned load balancer 102 for delivery via either access network 112 or core network 114.

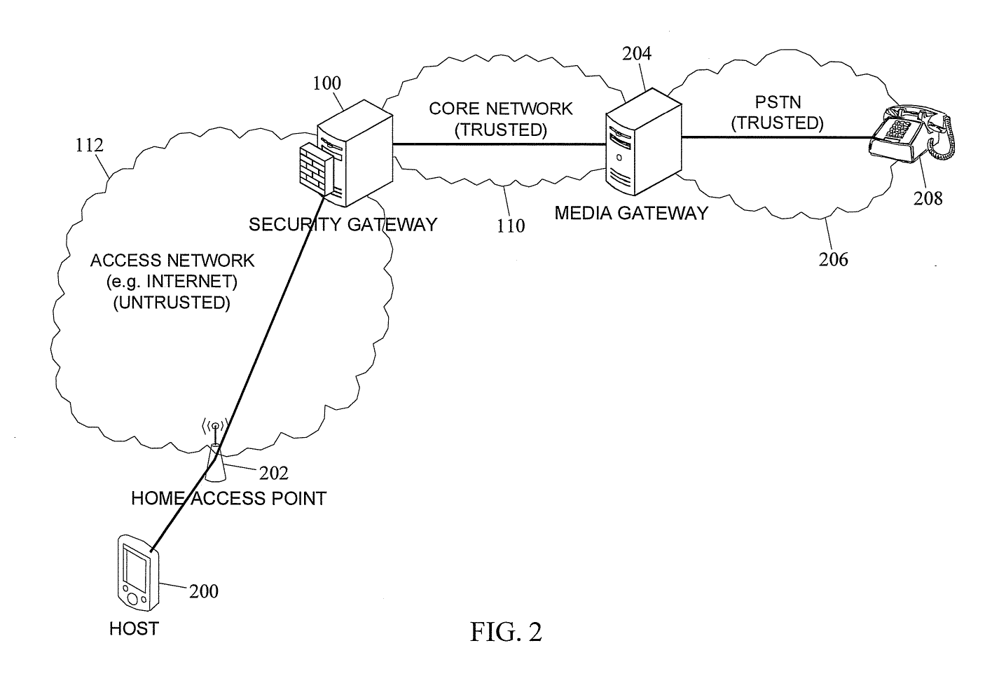

FIG. 2 is a network diagram of an exemplary network configuration including a load sharing security gateway that maintains flow affinity to sessions according to an embodiment of the subject matter described herein. Referring to FIG. 2, SG 100 may be connected to core network 110 and access network 112. Host 200 may communicate with SG 100 via access network 112 and require IPSec-secured communications. In the embodiment shown in FIG. 2, host 200 may include a personal data assistant (PDA)/mobile phone that is wirelessly connected to a home access point 202. Home access point 202 may be configured to establish IPSec sessions in behalf of host 200.

SG 100 may also be connected to a media gateway (MG) or other network device via core network 110. For example, MG 204 may reside at the edges of core network 110 and PSTN 206 and may communicate with conventional landline telephone 208. Thus, IPSec packet flows exchanged between home access point 202 and SG 100 may be decrypted into cleartext packets for transmission via core network 110 to MG 204. MG 204 may then convert the unencrypted packets to a format suitable for communication with phone 208 (e.g., a voice call).

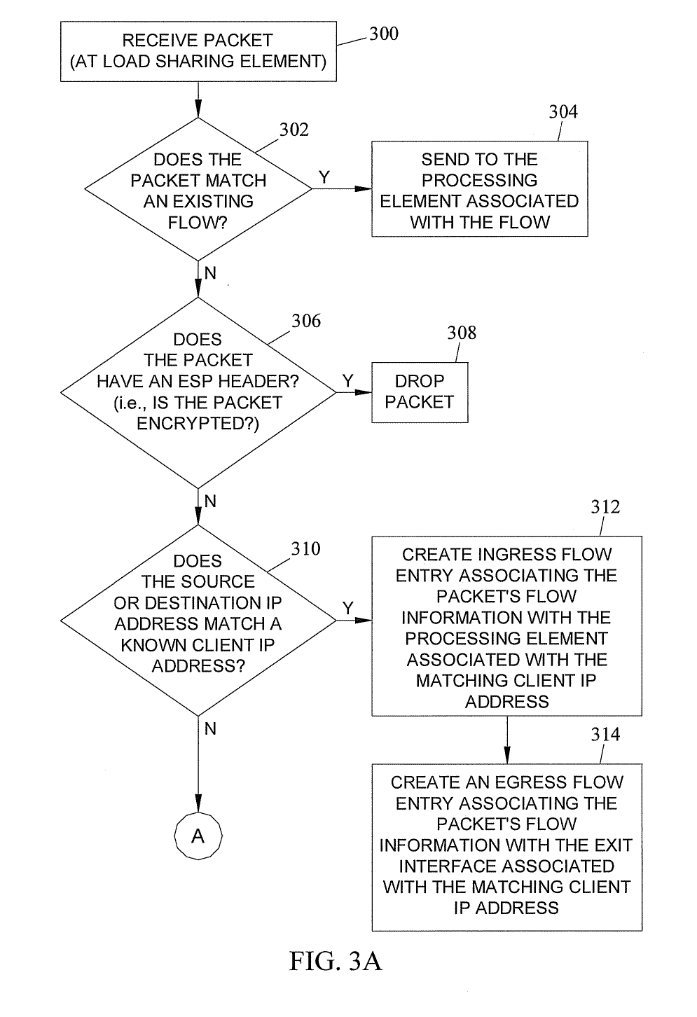

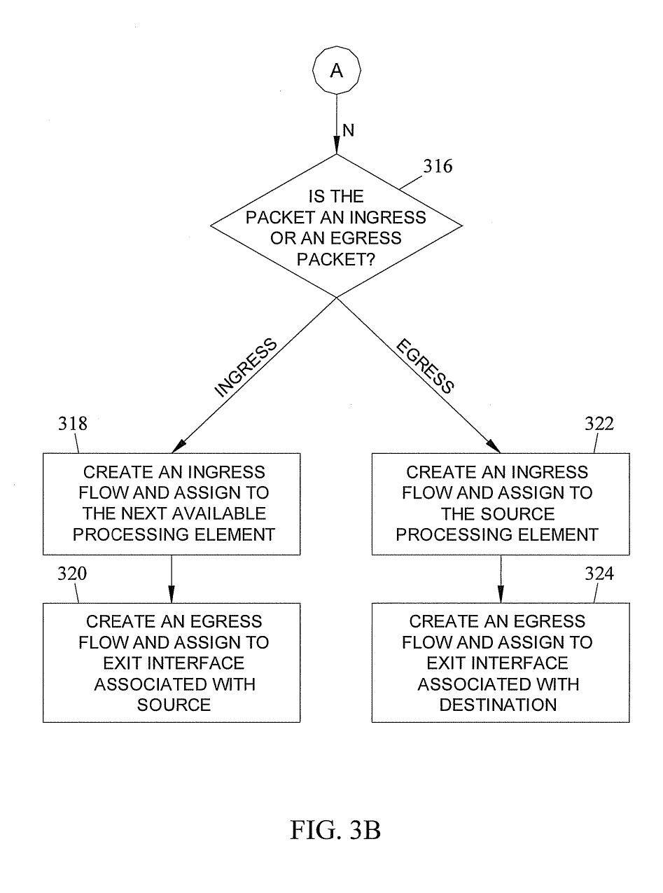

FIGS. 3A and 3B are a flow chart showing exemplary steps performed by a load-balancing security gateway for maintaining flow affinity to IPSec sessions in according to an embodiment of the subject matter described herein. Referring to FIG. 3, in step 300, a packet is received by the security gateway. For example, an encrypted ingress packet may be received via access network 112 from host 200, a clear ingress packet may be received via core network 110 from MG 204, or an encrypted (or clear) egress packet may be received via an internal communications bus (not shown) from one of processing elements 104 or 106.

In step 302, it is determined whether the packet matches an existing flow. As mentioned above, a flow may be defined by its N-tuple, such as the 5-tuple <source IP, destination IP, TCP source port, TCP destination port, protocol> for unencrypted TCP/IP packet flows or the 4-tuple <source IP, destination IP, protocol, SPI> for IPSec flows. Thus, flow engine 108 may search the N-tuples in flow database 116A for a match. If a match is found, the packet is processed in a manner similar to that used for other packets belonging to the same flow according to step 304 (i.e., sent to the processing element associated with the flow).

However, if instead it is determined in step 302 that the packet does not match an existing flow, then the packet is either routed to the processing element to which its flow is affined, affined to the next available processing element, or dropped.

In step 306, it is determined whether the packet is encrypted. For example, the packet may be examined to determine whether authentication header (AH) or ESP are used. For the sake of simplicity, ESP will be used when describing the security services to be applied to packets requiring IPSec processing. However, it is appreciated that ESP may be used alone or in combination with AH, and that additional protocols may be used to help provide IPSec services without departing from the scope of the subject matter described herein. If the packet is encrypted, the packet is dropped according to step 308. Because the original IP header information cannot be obtained (i.e., inner IP header is encrypted), the packet cannot be matched to a session, and thus to a processing element.

However, if the packet is unencrypted (i.e., clear), the N-tuple can be read and the packet can be matched to a flow. Specifically, in step 310, it is determined whether the source or destination IP address matches a known client IP address. If the source or destination IP address does match an existing client IP address, then, in step 312, an ingress flow is created and assigned to the processing element associated with the matching client ID determined in step 312 and, in step 314, an egress flow is created and assigned to the exit interface of the client ID determined in step 310.

Alternatively, if it is determined in step 310 that neither the source nor the destination IP address matches a known client IP address, then control proceeds to step 316 where it is determined whether the packet is an ingress packet or an egress packet. If the packet is an ingress packet, in step 318, an ingress flow is created and assigned to the next available processing element and, in step 320, an egress flow is created and assigned to the exit interface associated with the source.

Returning to step 316, if the packet is an egress packet, in step 322, an ingress flow is created and assigned to the source processing element and, in step 324, an egress flow is created and assigned to the exit interface associated with the destination.

In summary, the algorithm shown in FIGS. 3A and 3B, written in pseudo-code, is as follows:

```
if(ingress packet)
        if(ESP) {drop packet}
        else if(src or dst IP matches client IP)
                {create ingress flow and assign to owner of client IP;
                create egress flow and assign to exit interface of
                client}
        else {create ingress flow and assign to next available element;
                create egress flow and assign to exit interface of
                source}
if(egress packet)
        if(ESP) {drop packet}
        else if(src or dst IP matches client IP)
                {create ingress flow and assign to owner of client IP;
                create egress flow and assign to exit interface of
                client}
        else {create egress flow to exit interface of destination;
                create ingress flow and assign to source element}
```

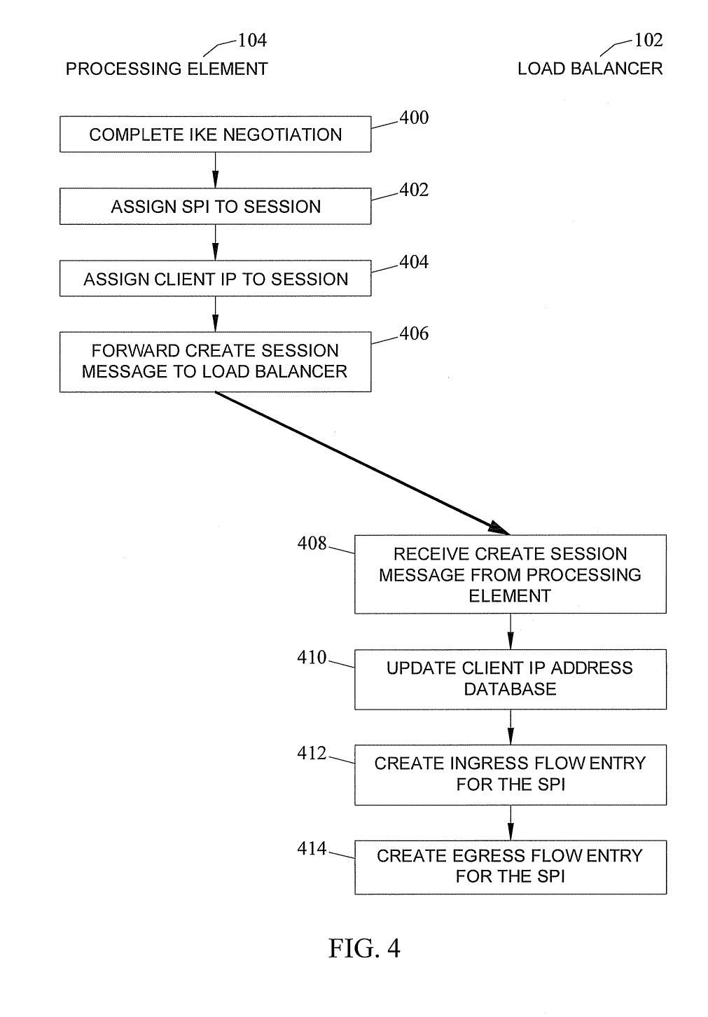

FIG. 4 is a flow chart showing exemplary steps performed when an IPSec session is created according to an embodiment of the subject matter described herein. Referring to FIG. 4, upon completion of IKE negotiation in step 400, an SPI is assigned to the session in step 402 and a client IP is assigned to the session in step 404. Importantly, the processing element may generate a CREATE_SESSION message for communicating information to the load balancer in order for load balancer to keep track of which processing element is associated with each IPSec session. For example, processing element A 104 may generate a CREATE_SESSION message that includes the assigned (local and/or peer) SPI, the assigned client IP address, and the processing element identifier for the IPSec session.

In step 408, the CREATE_SESSION message is received from processing element 104 at load sharing module 102. Using the information contained in the CREATE_SESSION message, load sharing module 102 updates its client IP address database in step 512. For example, load sharing module 102 may update client IP address database 118 to include client IP address associated with host 200. Load sharing module 102 may also create ingress and egress flows for the SPI in steps 412 and 414, respectively. For example, control processor 110 may update flow databases 116A and 116B to include flow entries associating the N-tuple associated with the flow with the processing element identifier for processing element 102.

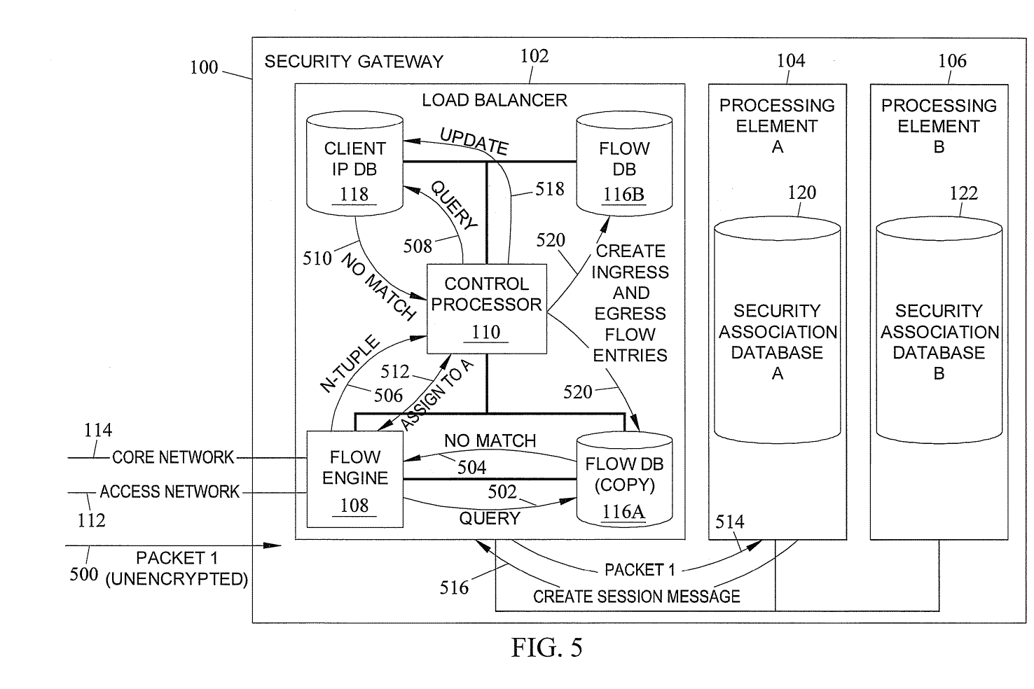

FIG. 5 illustrates a scenario in which a received packet is not associated with any known flow or session and, therefore, is routed to the next available processing element according to an embodiment of the subject matter described herein. Referring to FIG. 5, at step 500, packet_1 is received by flow engine 108 of SG 100. In step 502, flow engine 108 may search flow database 116A to locate a matching entry (i.e., step 300 of FIG. 3A). As described above, this may include searching flow DB 116A for an entry matching the N-tuple included in the packet header that defines the packet flow to which it belongs. Finding no match in step 504, flow engine 108 may then extract and send the N-tuple for the packet to control processor 110 in step 506 in order to determine whether either of processing elements 104 or 106 have previously processed the flow to which packet_1 belongs.

Next, control processor 110 may determine whether packet_1 is encrypted or unencrypted (i.e., step 306 of FIG. 3A). In the scenario shown, packet_1 may be the first packet received by SG 100 for requesting establishment of an IPSec session. Because the various security protocols have not yet been negotiated, packet_1 is an unencrypted packet, such as a user datagram protocol (UDP)/IP packet.

In step 508, control processor 110 may query client IP address DB 118 in order to determine whether either the source or the destination IP address included in packet_1 matches a known client IP address (i.e., step 310 of FIG. 3A). However, because packet_1 is the first packet received by SG 100 and, thus, is not associated with any previous known flow, session, or client connection, client IP DB 118 may return a response in step 510 indicating that no match was found.

In step 512, control processor 110 may assign the flow to which packet_1 belongs to the next available processing element. For example, control processor 110 may assign packet_1, and its flow, to processing element A 104 based on a suitable algorithm, such as round robin or lowest utilization algorithms. After determining the next available processing element to which to assign packet_1 in step 514, flow engine 108 may route packet_1 to processing element A 104 for IPSec processing. For example, processing element A 104 may assign an SPI and a client IP address to the IPSec session (i.e., steps 402 and 404 of FIG. 4). It is appreciated that when processing element A 104 (or any processing element), creates a new IPSec session, processing element A 104 assigns an IPSec SPI to the session which may be inserted in the ESP header of encrypted packets and a client IP address which may be inserted in the IP header of unencrypted packets.

In step 516, processing element A 104 may communicate the local and peer IPSec SPIs, the client IP address, and the processing element identifier to load balancer 102. For example, processing element A 104 may generate and insert this information in a CREATE_SESSION message. It is appreciated, however, that other message types may be used for communicating the assigned IPSec SPI, peer SPI, and client IP address to load balancer 102 without departing from the scope of the subject matter described herein.

Upon receiving CREATE_SESSION message in step 516, control processor 110 may update client IP address database 118 in step 518 (i.e., step 410 of FIG. 4). For example, control processor 110 may create/update an entry in client IP database 118 including the client IP address, SPI, and processing element identifier. As a result, the IPSec session may be determined along with the processing element to which it is assigned. Furthermore, packets belonging to packet flows that are received by SG 100 may subsequently be affined to an IPSec session defined in client IP database 518, and this affinity may be maintained for the duration of the IPSec session such that the same processing element is responsible for processing all flows belonging to the IPSec session.

Finally, in step 520, control processor 110 may create ingress and egress flow entries in flow databases 116A and 116B. For example, control processor 110 may create an ingress flow entry containing the N-tuple extracted from packet_1 (e.g., 5-tuple <source IP, destination IP, source port, destination port, protocol>) that is associated with processing element identifier ‘A’ corresponding to processing element A 104 (i.e., step 412 of FIG. 4). Likewise, control processor 110 may create an egress flow entry containing the N-tuple extracted from packet_1 (e.g., 5-tuple <source IP, destination IP, source port, destination port, protocol>) that is associated with the exit interface associated with the source IP address (i.e., step 414 of FIG. 4).

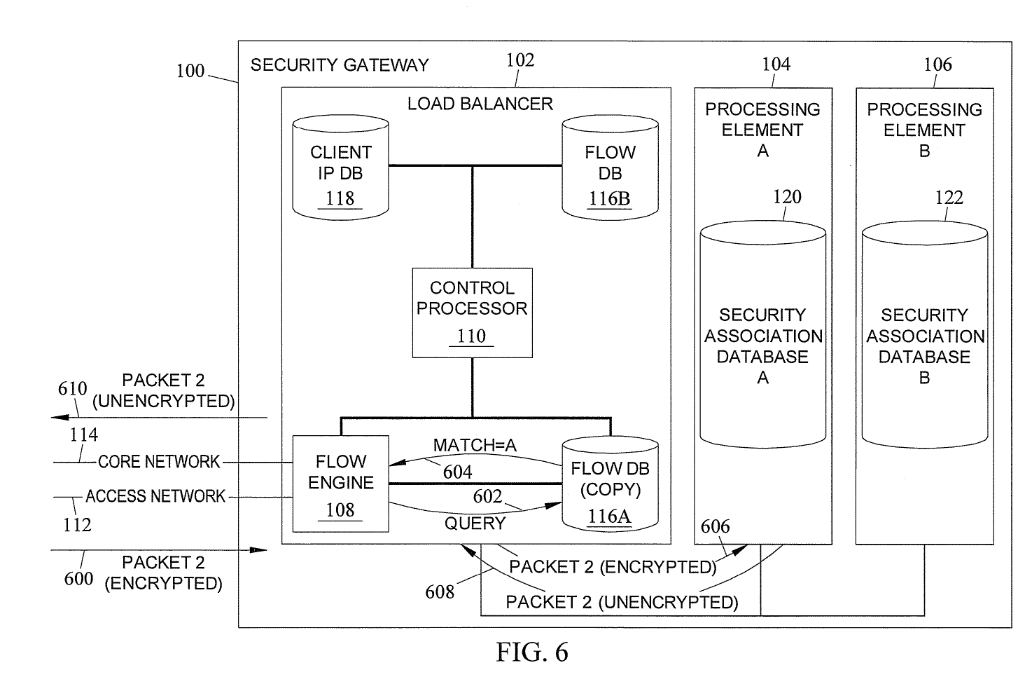

FIG. 6 illustrates a scenario in which a received packet is associated with a previous flow and IPSec session and, therefore, is routed to the same processing element associated with the flow/session according to an embodiment of the subject matter described herein. Referring to FIG. 6, at step 600, packet_2, which has been encrypted using the IPSec protocols negotiated by processing element A 104 and, for example, home access point 202 of FIG. 2, is received by flow engine 108 via access network 112. Flow engine 108 may then extract predetermined packet header data in order to search its copy of flow DB 116A for a matching entry in step 602 (i.e., step 302 of FIG. 3A). For example, because it is assumed in this scenario that packet_2 belongs to the same flow as packet_1, the N-tuple extracted from packet_2 may include the same source IP address, destination IP address, and SPI as that of packet_1.

As a result, flow database 116A may locate a matching entry and return a query result indicating that the flow associated with packet_2 is assigned to processing element A 104. Flow engine 108 may then forward packet_2 to processing element A 104 for IPSec processing in step 606 (i.e., step 304 of FIG. 3A). For example, upon receiving encrypted packet_2, processing element A 104 may utilize information included in SAD 120 to decrypt packet_2. In step 608, unencrypted packet_2 is returned to flow engine 108, where it may be transmitted via a suitable exit interface to its destination or next hop in step 610.

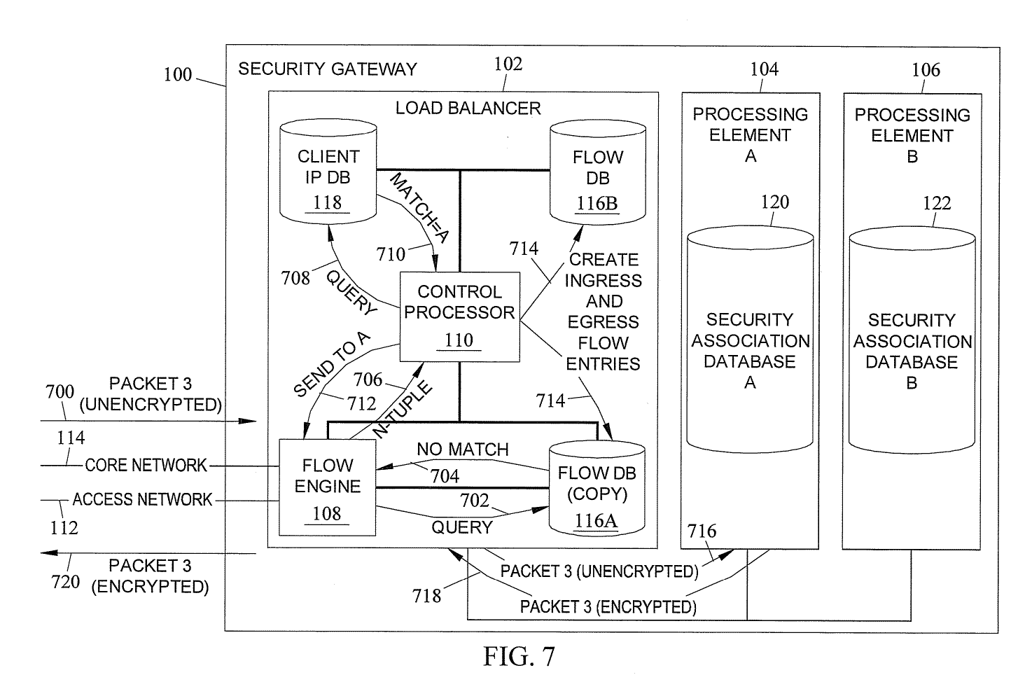

FIG. 7 illustrates an alternative scenario in which a received packet belongs to a new packet flow but a known IPSec session and, therefore, is routed to the same processing element associated with the session according to an embodiment of the subject matter described herein. Referring to FIG. 7, at step 700, packet_3, is received by flow engine 108 via core network 110. In the scenario shown, packet_3 may be unencrypted because it is received from core network 110, which is a trusted network. Flow engine 108 may then extract predetermined packet header data in order to search its copy of flow DB 116A for a match in step 702. In contrast to the scenario described above in FIG. 6, packet_3 does not match any known packet flow. Thus, flow DB 116A may return a query result indicating that no match was found in step 704.

In step 706, flow engine 108 may extract and send the N-tuple for packet_3 to control processor 110. In step 708, control processor 110 may query client IP database 118 to determine whether either the source or the destination IP address included in packet_3 matches a known client IP address (i.e., step 310 of FIG. 3A). Because the destination IP address included in packet_3 is the same as the IP address of host 200/home access point 202, which previously established an IPSec session with SG 100 as described above with respect to FIG. 5, the IP address of host 200/home access point 202 is located in client IP database 118. Thus, in step 710, client IP database 118 may return a query result indicating that a match was found and, furthermore, that the IPSec session to which the flow to which packet_3 belongs has previously been assigned to processing element A 104.

In step 712, control processor 110 may instruct flow engine 108 to forward packet_3 to processing element A 104. Additionally, because packet_3 is the first packet of a new flow, in step 714, control processor 110 may create ingress and egress flow entries for packet_3 indicating that the N-tuple defining the flow to which packet_3 belongs is associated with processing element A (i.e., steps 312 and 314 of FIG. 3A).

In step 716 flow engine 108 may then forward (still unencrypted) packet_3 to processing element A 104 for IPSec processing. Upon receiving encrypted packet_3, processing element A 104 may utilize information included in SAD 120 to encrypt packet_3. Additionally, IPSec processing may include, adding an ESP header and trailer, encrypt the packet as the inner packet, and encapsulate the inner packet by adding an outer IP header. In step 718, encrypted packet_3 is returned to flow engine 108 where, in step 720, it is transmitted via a suitable exit interface for delivery to its destination or next hop address.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for maintaining flow affinity to Internet protocol security (IPSec) sessions in a load-sharing security gateway (SG), the method comprising:
receiving packets at a security gateway that provides communication of packet flows between source and destination entities using IPSec sessions;
for each packet, determining whether the packet is assigned to an existing packet flow between a source and a destination entity that is being processed by the SG;
in response to determining that the packet belongs to an existing flow, forwarding the packet to a processing element associated with that flow and performing IPSec processing at the processing element; and
in response to determining that the packet does not belong to an existing flow, defining a new flow and assigning the flow to a next available processing element and performing IPSec processing for the flow at the next available processing element.

2. The method of claim 1 wherein receiving packet at the SG includes receiving one of an encrypted and an unencrypted packet.

3. The method of claim 1 wherein receiving packet at the SG includes receiving one of an ingress packet and an egress packet.

4. The method of claim 1 wherein receiving packet at the SG includes receiving a packet from one of a trusted network and an untrusted network.

5. The method of claim 4 wherein the trusted network includes the public switched telephone network.

6. The method of claim 4 wherein the untrusted network includes the Internet.

7. A system for maintaining flow affinity to Internet protocol security (IPSec) sessions, the system comprising:
a load-sharing security gateway (SG) that provides communication of packet flows between source and destination entities using IPSec sessions and, the security gateway including:
a plurality of processing elements for performing processing for packets and packet flows; and
a load-sharing module being communicatively coupled to each of the plurality of processing elements and configured to load share packet flows among the processing elements, and for:
receiving packets;
for each packet, determining whether the packet is assigned to an existing packet flow between a source and a destination entity that is being processed by the SG;
in response to determining that the packet belongs to an existing flow, forwarding the packet to a processing element associated with that flow and performing IPSec processing at the processing element; and
in response to determining that the packet does not belong to an existing flow, defining a new flow and assigning the flow to a next available processing element and performing IPSec processing for the flow at the next available processing element.

8. The system of claim 7 wherein the plurality of processing elements is configured to communicate an assigned SPI, a peer SPI, and a client IP address associated with the session to the load sharing module.

9. The system of claim 7 wherein, in response to receiving the create session message, the load-sharing module is configured to:
update a client IP address database with the received client IP address;
create an ingress ESP flow for the assigned SPI; and
create an egress ESP flow for the peer SPI.

10. A computer readable medium comprising computer executable instructions embodied in a tangible computer readable medium and when executed by a processor of a computer performs steps comprising:
receiving packets at a security gateway that provides communication of packet flows between source and destination entities using IPSec sessions;
for each packet, determining whether the packet is assigned to an existing packet flow between a source and a destination entity that is being processed by the SG;
in response to determining that the packet belongs to an existing flow, forwarding the packet to a processing element associated with that flow and performing IPSec processing at the processing element; and
in response to determining that the packet does not belong to an existing flow, defining a new flow and assigning the flow to directing the first flow to a next available processing element and performing IPSec processing for the flow at the next available processing element.
